(19) United States
(12) Patent Application Publication
(10) Pub. No.: US 2026/0165353 A1
(43) Pub. Date: Jun. 18, 2026

(54) METHODS, SYSTEMS AND COMPOSITIONS RELATING TO USING COMPACTION TO FORM SALT GRANULES FROM POWDERED SALT COMPOSITIONS

(71) Applicant: Microsalt PLC, London (GB)

(72) Inventors: Javier Contreras, Odessa, NY (US); Ahmad Akashe, Mundelein, IL (US)

(73) Assignee: Microsalt PLC, London, EN (GB)

(21) Appl. No.: 18/980,702

(22) Filed: Dec. 13, 2024

(51) Int. Cl. A23L 27/40; B02C 23/02; B02C 23/10

(52) U.S. Cl. CPC A23L 27/40; B02C 23/02; B02C 23/10

(57) ABSTRACT

The present invention relates to a method for producing low sodium salt granules by compacting low sodium salt in powdered form with a roller compaction machine and the low sodium salt granule product resulting from such a method. In accordance with some embodiments, the method may include feeding a low sodium salt powder composition comprising salt adhered to a carrier particle formed by a specified method into a roller compaction machine and compacting the low sodium salt powder form to form a compacted sheet or ribbon. The sheet may then be milled or otherwise broken down into durable low sodium salt granules to improve the handling, dispensing and/or other properties of the low sodium salt composition for applications in which a human applied the low sodium salt as opposed to a machine.

### FIELD OF THE INVENTION

The present invention relates to the field of foods and food processing, specifically, to methods, systems and compositions related to the formation of granulated salt from powdered salt compositions.

### BACKGROUND

Salt is a staple seasoning and is commonly used to flavor various food products, however, too much sodium intake can lead to several health issues including high blood pressure which can lead to cardiovascular disease, kidney damage, and fluid retention and edema, among other things.

According to the World Health Organization, cardiovascular diseases are the leading cause of death globally, with approximately 17.9 million people dying from cardiovascular diseases in 2019, representing 32% of all global deaths. Of these deaths, 85% were due to heart attack and stroke.¹ According to the Centers for Disease Control, “About 610,000 people die of heart disease in the United States every year—that's 1 in every 4 deaths.” In the U.K., there are about 160,000 deaths from heart disease each year accounting for 26% of all deaths. ¹WORLD HEALTH ORGANIZATION (WHO), Cardiovascular Diseases (CVDs), 2021 Jun. 11 (https://www.who.int/news-room/fact-sheets/detail/cardiovascular-diseases-(cvds))

According to Yi-Jie Wang et al², every gram (lg) of dietary sodium intake increases the risk of cardiovascular disease by 6%. ²WANG Y J, YEH T L, SHIH M C, TU Y K, CHIEN K L, Dietary Sodium Intake and Risk of Cardiovascular Disease: A Systematic Review and Dose-Response Meta-Analysis, webpage, 2020 Sep. 25 (https://www.ncbi.nlm.nih.gov/pmc/articles/PMC7601012/#:˜:text=The%20risk%20of%20CVD%20with.risk%20of%20CVD%20by%206%25)

Accordingly, it would be beneficial to decrease sodium content in foods and on food products to promote lower human sodium consumption. This may be achieved by offering low-sodium salt compositions that deliver a salty flavor profile that is similar in taste and texture to traditional table salt, while reducing overall sodium intake.

In general, offering a low sodium salt composition as a replacement for traditional table salt may provide several health benefits. For example, lower sodium intake can reduce the risk of heart disease and stroke by minimizing the adverse effects on the heart and circulatory system. Moreover, reducing sodium intake may help lower blood pressure, which is crucial for preventing hypertension and related cardiovascular diseases. Additionally, lowering sodium intake may prevent kidney damage and other issues.

U.S. Pat. No. 8,900,650 describes a low sodium salt composition including a carrier particle having disposed thereon a plurality of salt crystallites. The methods include providing an aqueous slurry comprising an aqueous solvent and a selected percent by weight of a solids mixture, wherein the solids mixture comprises salt and a carrier medium, and wherein the carrier medium is present in an amount between about 25% by weight and about 75% by weight of the aqueous solvent; and exposing the slurry to a drying process to both: a) form a carrier particle comprised of the carrier medium; and b) form a plurality of salt particles of an average size of less than about 20 microns on the surface of the carrier particle, with the salt particles on the surface of the carrier particle having an average size ranging from 100 nanometers to less than 2 microns.

The carrier particle in the low sodium salt-carrier product described in U.S. Pat. No. 8,900,650 can be a bulking agent, carbohydrate or its derivative, starch, maltodextrin, hydrocolloid, protein, protein derivative, starch, pre-gelatinized starch, modified starch, pyrodextrin, gum, cereal flour, or tuber flour yeast extract, flavor enhancer, or lipid. The drying process can include freeze drying, spray drying, spray cooking, or roll drying process.

U.S. Pat. No. 11,992,034 describes an improved low-sodium salt composition, where the salt-particles adhered to the carrier particle are of an average size of less than 2 microns to less than 100 nanometers and the resultant salt-carrier particles coat and adhere better to foods, such as potato chips, nuts, popcorn, or other foods than salt that is not adhered to a carrier particle.

The foregoing methods and systems for lowering sodium content in salt have been successful in producing salt-carrier particles with lower sodium content than traditional salts (e.g., 50% less sodium without compromising the salt intensity and taste profile), however, a drawback of such compositions is that such a composition has is a very fine powder with fairly a low bulk density (in the range of 40 μm, and a bulk density of 0.35-0.5 g/ml). Because of those physical properties, those low sodium salts tend to flow in a nonuniform manner and be subject to excessive dusting. Additionally, when exposed to a high heat and humidity environment, those low sodium salt composition may exhibit powder caking. The powdery consistency and texture has advantages in certain applications, such as in applications to nuts, chips, and crackers where the low sodium salt composition is applied with machines or in baking, where the powdery consistency can make it easier to be applied in a more consistent and precise manner, such as when salt, flour, or baking powder or soda are applied by leveling off a spoon, cup, or other container, or by weight to ensure precise application. Moreover, such a powdery salt may dissolve at a much faster rate and becomes completely available during mastication of food, whereas when salt crystals are large and dense (e.g., granular table salt or granular sea salt), their dissolution rate tends to be much slower and longer, and in most cases, longer than the typical mastication of food. This may result in a significant amount of salt becoming less available for perceived saltiness during eating times.

However, the powdery consistency can pose a challenge in applications involving human handling and dispensing, such as when applied to French Fries or a diner adding salt from a salt shaker or other salt application device to food by human hand where the powder consistency may make it difficult to apply the low sodium salt uniformly with precise control over the amount applied. For example, such a low sodium salt composition that has a powdery consistency can be prone to clumping, airborne dust, and inconsistent flow, which may complicate its handling and use in particular applications. Accordingly, it may be desirable to convert the texture of such powdered low sodium salt composition into larger composition for certain applications while retaining the health benefits of a composition that remains lower in sodium. Moreover, it may be desirable to produce low sodium salt granules that have the same or similar appearance, flowability and other characteristics of traditional salt with a lower total sodium profile, and a higher (e.g., much higher) dissolution rate than traditional table salts. The present disclosure contemplates using a compaction system and process to transform low sodium salt-carrier compositions of a low-density fine powder consistency into a more granular form, to improve the composition's handling, dispensing, flowability, dissolution rate and other properties to allow for more precise pouring and with more control for applications where salt is applied by human hand as opposed to machine.

### SUMMARY OF THE INVENTION

The invention provides a process for forming low sodium salt granules by utilizing a compaction system and method such as, but not limited, to roller compaction system and method designed to produce compacted low sodium salt sheets. The compacted sheets may subsequently be milled or otherwise broken down into low sodium salt granules, to prevent excess clumping, create even sized low sodium salt granules, and offer a convenient solution for low sodium salt granule processing and distribution particularly suited for application by human hand.

It is an object of the present invention to provide a process for compacting a base low sodium salt-carrier product using a compacting process to merge individual low sodium salt-carrier particles (e.g., low sodium salt-carrier powder particles) together.

It is an object of the present invention to provide a compaction system and/or process which includes the steps of applying pressure on fine salt powder to form a solid sheet of salt mass (e.g., a ribbon), which can be milled and screened to a desired size. In any embodiment, the application of compaction pressure may include (but is not limited to) pressing powder between two rollers for a specified pressure and pressing time, pressing salt powder between a roller and flat surface, or pressing a powder into a mold or cavity (similar to tableting or palletizing, etc.).

It is an object of the present invention to provide a process for compacting a base low sodium salt-carrier product using a roller compacting process to produce low sodium salt granules that generally have better flow and dispensing characteristics compared to low sodium salt powders.

It is an object of the present invention to provide a process for compacting a base low sodium salt-carrier product using a compacting process (e.g., roller compaction) to produce durable (e.g., substantially non-degradable upon blending) granulated low sodium salt with improved flowability.

It is an object of the present invention to provide a process for compacting a base low sodium salt-carrier product using a compacting process (e.g., roller compaction) to produce semi-spheric irregular shaped granulated low sodium salt.

It is an object of the present invention to provide a granulated low sodium salt that has the appearance, flowability and taste profile (e.g., intensity) of granular table salt, but with the benefits and advantages of reducing sodium content up to 50% because of the high dissolution rate of the modified salts.

It is an object of the present invention to provide a process for compacting a base low sodium salt-carrier product using a compacting process (e.g., a roller compaction process) utilizing relatively low roller force and/or roller pressure (roller pressure may be measured based on the roll force applied by the roller divided by the effective contact area between the rollers, for example, the roller pressure may be measured by dividing the force-pound per the roller width size). In some scenarios, the roller force may be 3000 to 4000 pounds-force (lbf) (approximately 13,344 to 17,792 Newtons (N) of force) and the roller pressure (measured per inch or centimeter of roller width (e.g., per inch or centimeter of the surface area that comes in contact with the material when the material travels through the roller compactor machine)) may be 2500 to 3300 lbf/in (approximately 4,378 to 5,779 N/cm). Such a process may produce a better processable compaction, with less brittle low sodium salt ribbons or sheets which can be milled with ease (e.g., when compared to processes utilizing higher roller force or pressure to produce low sodium salt sheets or ribbons for eventual milling).

It is an object of the present invention to provide a process for compacting a base low sodium salt-carrier product using a compacting process (e.g., a roller compaction process) to produce low sodium salt granules exhibiting improved compressibility, which may lead the granules to have enhanced integrity and durability (e.g., better binding and mechanical strength when compared to salts, other low sodium salts).

It is an object of the present invention to provide a process for compacting a base low sodium salt-carrier product using a compacting process (e.g., a roller compaction process) which may require no additional binder agents or additives compared to other granulation methods, which may result in a more cost-effective cleaner production process, in addition to a healthier end-product. In some scenarios, the process may utilize minimal use of binder agents to support granule compaction.

It is an object of the present invention to provide a process for compacting a base low sodium salt-carrier product using a roller compacting and/or milling process to allow for precise control over the size and distribution of the low sodium salt granules to support producing a uniform product, whose size parameters may be adjusted based on specific output requirements.

It is an object of the present invention to provide a process for compacting a base low sodium salt-carrier product using a roller compacting and/or milling process to help achieve a granular low sodium salt product with uniform particle size distribution.

It is an object of the present invention to provide a method for milling compacted sheets of low sodium salt compositions to break the compacted sheets down into uniform, smaller granules

It is an object of the present invention to provide a method for milling compacted sheets of low sodium salt compositions to allow for precise control over the final particle size distribution, ensuring the low sodium salt granules meet specific specifications for various uses, including being sized to match the size of conventional table salts and other salts utilized in commercial restaurant chains (e.g., McDonald's® salt).

It is an object of the present invention to provide a method for milling compacted sheets of low sodium salt compositions to help achieve a homogeneous product by breaking up large lumps or inconsistently sized particles. In some scenarios, this may support creation of a final product that has a consistent quality and performance.

In accordance with embodiments of the present invention, a low sodium salt powder composition may be formed by one or more of the processes described in U.S. Pat. Reg. No. 11,992,034, for example, a process comprising: providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle. In accordance with some embodiments, the low sodium salt powder composition formed utilizing the foregoing process may be transformed using the roller compaction and/or milling method disclosed herein to form low sodium salt granules and/or crystals.

In accordance with embodiments of the present invention, a low sodium salt powder composition may be formed by one or more of the processes described in U.S. Pat. Reg. No. 11,992,034, for example, a process comprising: providing an aqueous salt-carrier slurry comprising an aqueous solvent and a selected percent by weight of a solids mixture, wherein the solids mixture comprises a salt present in an amount between about 2.5% by weight and less than 14.9% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle. In accordance with some embodiments, the low sodium salt powder composition formed utilizing the foregoing process may be transformed using the roller compaction and/or milling method disclosed herein to form low sodium salt granules and/or crystals.

In accordance with embodiments of the present invention, a method for producing a granular low sodium salt composition may comprise: providing a low sodium salt powder composition comprising one or more salt particles adhered to a bulk carrier, feeding the low sodium salt powder composition into a roller compaction machine, compacting the low sodium salt powder composition using the roller compaction machine to form a low sodium salt compacted sheet, and reducing the low sodium salt compacted sheet into low sodium salt granules to obtain granular low sodium salt composition. In some embodiments, two rollers of the roller compaction, each having a width of 1.22 inch (3.1 cm), may operate at a roller force the range of 2500 to 4500 lbf (approximately 11,120 to 20,017 Newtons). In some embodiments, the roller compaction machine, which may comprise a pair of rollers with a width of 1.22 inch (3.1 cm), may operate at a roller force in the range of 3000 to 3500 lbf (approximately 13,345 to 15,569 Newtons). In some embodiments, operating at such a roller force or pressure may be configured to prevent production of brittle low sodium salt sheets or cause mill jams. In some embodiments, the roller compaction machine may operate at a screw speed in the range of 4 to 55 RPM. In some embodiments, the roller compaction machine may operate at a screw speed in the range of 6 to 22 RPM. In some embodiments, a gap formed between two counter-rotating rollers of the roller compaction machine may be 0.08 to 0.09 inches. In some embodiments, the roller compaction machine may operate at a roller speed in the range of 4 to 14 RPM. In some embodiments, the roller compaction machine may operate at a roller speed in the range of 6 to 12 RPM. In some embodiments, the roller compaction machine may operate at a screw speed in the range of 6 to 15 RPM, a roll speed in the range of 6 RPM to 12 RPM, a roll force in the range of 3000 to 3500 lbf (approximately 13,345 to 15,569 Newtons) and a mill speed in the range of 150 RPM to 250 RPM. In some embodiments, the roller compaction machine may operate without jamming the mill or producing brittle low sodium salt sheets. In most roller compactors, the process is continuous and therefore the mill speed needs to be adjusted to keep up with compaction rate. In some cases where compaction can be carried out in a non-continuous fashion (e.g., where compaction is carried out to prepare sheets or ribbons), ribbons are collected and milled independently at a desired rate to provide a desired particle size distribution. In some embodiments, the granular low sodium salt composition produced by the claimed process may be durable and substantially non-degradable. In some embodiments, the granular low sodium salt composition produced by the roller compaction process may possess improved handling, dispensing, and flowability characteristics when compared to powdered low sodium salt compositions. In some embodiments, the granular low sodium salt composition produced by the roller compaction process may comprise non-spherical, irregular shape such as in table salt granules. In some embodiments, the particle size of the resultant low sodium salt granule or crystal composition may be between 100 μm-1000 μm (for example, between 150 μm-700 μm) (e.g., depending on the type of mesh screen used) the low sodium salt granules may have a bulk density in a range of 0.60 grams per milliliter (g/ml) to 0.95 g/m. In some embodiments, the low sodium compacted sheet may be reduced to granules using a milling process with a mill varying mill speed, for example, of 100 to 300 RPM. Milling can be achieved with any type of mill, for example, a hammer mill.

In accordance with embodiments of the present invention, a low sodium salt granule product produced by the following process: providing a low sodium salt powder composition comprising one or more salt particles adhered to a bulk carrier, feeding the low sodium salt powder composition into a roller compaction machine, compacting the low sodium salt powder composition using the roller compaction machine to form a low sodium salt compacted sheet, and reducing the low sodium salt compacted sheet into low sodium salt granules to obtain granular low sodium salt composition. In some embodiments, the roller compaction machine having a pair of rollers, each with a width of 1.22 inch (3.1 cm) and a roller diameter of 7.8 inches (200 mm), may operate at a roller force in the range of 2500 to 4500 lbf (approximately 11,120 to 20,017 Newtons). In some embodiments, the roller compaction machine may operate at a roller force in the range of 3000 to 3500 lbf (approximately 13,345 to 15,569 Newtons). In some embodiments, operating at the roller force or pressure may not produce brittle low sodium salt sheets or cause mill jams. In some embodiments, the roller compaction machine may operate at a screw speed in the range of 4 to 55 RPM. In some embodiments, the roller compaction machine may operate at a screw speed in the range of 6 to 22 RPM. In some scenarios, the screw feed rate may be adjusted relative to the compaction rate (e.g., to match compaction rate). For example, if the screw feed rate is too fast, it will over fill the area between the roller and powder may overflow over the rollers and into the mill. On the other hand, if the screw feed rate is too slow, and that same area is underfilled, that would affect the ribbon thickness and density which may similarly lead to undesirable results. In some embodiments, a 0.08 to 0.09 inch gap may be formed between two counter-rotating rollers of the roller compaction machine having a pair of rollers, each having a width of 1.22 inch (3.1 cm) and a roller diameter of 7.8 inches (200 mm). In some embodiments, the roller compaction machine may operate at a roller speed in the range of 4 to 14 RPM. In some embodiments, the roller compaction machine may operate at a roller speed in the range of 6 to 12 RPM. In some embodiments, the roller compaction machine may operate at a screw speed in the range of 6 to 15 RPM, a roll speed in the range of 6 RPM to 12 RPM, a roll force in the range of 3000 to 3500 lbf (approximately 13,345 to 15,569 Newtons), and a mill speed in the range of 150 RPM to 250 RPM. In some embodiments, the roller compaction machine may operate without jamming the mill or producing brittle low sodium salt sheets. In some embodiments, the low sodium salt granule product comprises low sodium salt granules that are durable and substantially non-degradable. In some embodiments, the low sodium salt granule product may possess improved handling, dispensing, and flowability when compared to powdered low sodium salt compositions. In some embodiments, the low sodium salt granule product comprises spherical granules. In accordance with embodiments of the present invention, the particle size of the resultant low sodium salt granule composition may be between 150 um-700 um (e.g., depending on the type of mesh screen used). In some embodiments, the low sodium salt granules may have a bulk density in a range of 0.60 grams per milliliter (g/ml) to 0.95 g/ml. In some embodiments, the low sodium compacted sheet may be reduced to granules using a milling process with an exemplary mill speed of 100 to 300 RPM (however, the specific mill speed may depend on the type and size of the mill utilized).

In accordance with embodiments of the present invention, the roller compaction machine may comprise a pair of rollers, each having a roller width, and the roller compaction machine may operate at a roller pressure in the range of 2000 to 3700 pounds-force per inch of each roller width or 3,502 to 6,479 Newtons per centimeter of each roller width. In some embodiments, the roller compaction machine may comprise at least one roller having a roller width, and the roller compaction machine may operate at a roller pressure in the range of 2000 to 3700 pounds-force per inch of the roller width or 3,502 to 6,479 Newtons per centimeter of the roller width.

In accordance with embodiments of the present invention, the roller compaction machine may comprise a pair of rollers, each having a roller width, and the roller compaction machine may operate at a roller pressure in the range of 2500 to 2900 pounds-force per inch of each roller width or 4,378 to 5,078 Newtons per centimeter of each roller width. In some embodiments, the roller compaction machine may comprise at least one roller having a roller width, and the roller compaction machine may operate at a roller pressure in the range of 2500 to 2900 pounds-force per inch of the roller width or 4,378 to 5,078 Newtons per centimeter of the roller width.

The details of various embodiments are set forth in the accompanying drawings and the description below. Other features and advantages will be apparent from the description and drawings, and from the claims.

### BRIEF DESCRIPTION OF THE DRAWINGS

FIG. 1 is a schematic flow diagram depicting the process for making the low sodium salt composition powder described herein.

FIG. 2 is a flow diagram depicting the process for roll compacting and milling the low sodium salt composition powder into granules or crystals.

FIG. 3 is an illustrative graphic demonstrating processes for roll compacting and milling the low sodium salt composition powder into granules.

FIG. 4 depicts an exemplary roller compaction machine and/or process that may be utilized to granulate low sodium salts in accordance with embodiments of the present invention.

FIG. 5 depicts a portion of an exemplary roller compaction machine and/or process that may be utilized to granulate low sodium salts in accordance with embodiments of the present invention.

FIG. 6 illustrates exemplary low sodium salt compositions before and after undergoing the roller compaction process of the present invention.

FIG. 7 depicts a graph demonstrating dissolution percentages for various salts, including the low sodium salts of the present invention.

FIG. 8 depicts a graph demonstrating dissolution percentages for various salts, including the low sodium salts of the present invention.

FIG. 9 depicts a graph demonstrating dissolution percentages for various salts, including the low sodium salts of the present invention.

### DETAILED DESCRIPTION OF ILLUSTRATIVE EMBODIMENTS

In the Summary above and in this Detailed Description, and the claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used—to the extent possible—in combination with and/or in the context of other particular aspects and embodiments of the invention, and in the invention generally.

In general, offering reduced sodium content as a replacement for traditional table salt may provide several health benefits. For example, lower sodium intake can reduce the risk of heart disease and stroke by minimizing the adverse effects on the heart and circulatory system. Moreover, reducing sodium helps lower blood pressure, which is crucial for preventing hypertension and related cardiovascular diseases. High sodium intake is linked to increased blood pressure, which can strain the heart and blood vessels.

In some scenarios, excessive sodium can strain the kidneys, which are responsible for regulating sodium balance and blood pressure. Reducing sodium can alleviate this strain and improve overall kidney function.

Accordingly, it would be beneficial to decrease sodium content in foods and on food products. This may be achieved by offering low-sodium salt compositions that deliver a salty flavor profile that is similar in taste and texture to traditional table salt, while reducing overall sodium intake.

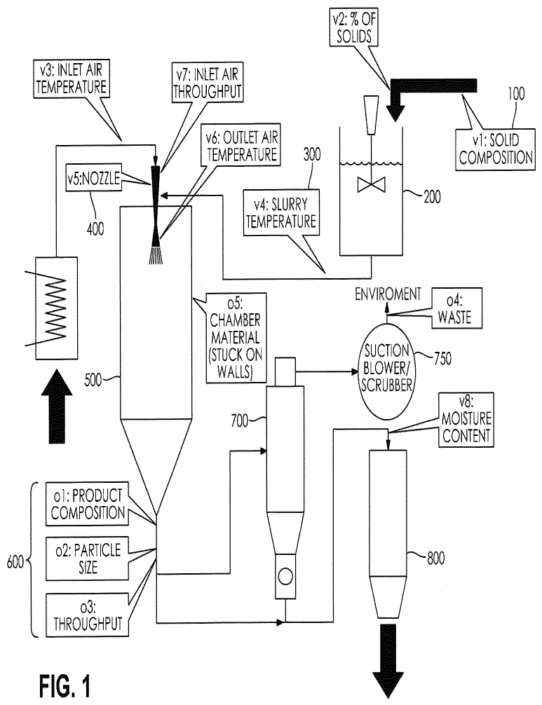

FIG. 1 is a schematic flow diagram of an exemplary process for making low sodium salt powder compositions (e.g., micronized salt-carrier product). As demonstrated by FIG. 1, low sodium salt powder compositions can be made, according to one of many methods, by carrying out the following steps, which need not necessarily be performed in the order presented.

At step 100, a solid composition of salt and a carrier is prepared to create a salt-carrier slurry by adding a selected carrier, preferably maltodextrin, to water in a tank with good agitation and heating the tank to a temperature of 176° F.±10° F. to dissolve the carrier and then add the salt to the tank and continuing to heat the aqueous salt-carrier solution at a temperature of 176° F.±10° F. and agitating it for sufficient time to ensure the salt is dissolved and it becomes an aqueous salt-carrier slurry at step 300. Alternatively, the salt and carrier could be combined with the water and heated at different temperatures for different times, so long as the salt, carrier, and water are substantially dissolved to become an aqueous salt-carrier slurry.

The concentration of salt in the salt solution can be adjusted to provide a desired coverage of salt on the resulting salt-carrier product. The salt can include single salts (e.g., sodium chloride) or a mixture of salts (e.g., sodium chloride, potassium chloride, ammonium chloride, etc.). The carrier can be any bulking agent, e.g., a powdered bulking agent, including but not limited to proteins, carbohydrates or their derivative(s), (maltodextrin, pre-gelatinized starch, gums, cereal flours and the like) and also including carbohydrates made up of small glucose molecules (e.g., tapioca), hydrocolloids, hydrolyzed proteins, yeast extracts, and flavorings. In some embodiments, a combination of different types of carriers can be used, e.g., a combination of a carbohydrate, a starch, and potassium salt can be used. The proportion of carrier to salt can be chosen to obtain a desired working density or other characteristic of the salt-carrier product. The salt-carrier mixture can then be mixed until homogeneous.

Examples of solid compositions used to create the salt-carrier slurry of the improved salt-carrier product include a salt plus carrier percent by weight of 11% to 39.9% aqueous solvent (water); a salt percentage by weight of aqueous solvent (water) of 3.9% to less than 25%; a carrier percentage of 2.77% to 24.9% by weight aqueous solvent (water); a salt plus carrier percentage by weight of aqueous salt-carrier slurry of 10 to 39.9%; a salt percentage by weight of aqueous salt-carrier slurry of 2.5% to 14.9%.

In an illustrative example, the percent solids in the slurry may be 25%, the percent of salt in the solids composition may be 70%, and the percentage of salt in the solution may be 17.5%. In such an example, the percent of carrier in the solids composition may be 30% and the percentage of carrier in the solution may be 7.5%.

In another illustrative example, the percent solids in the slurry may be 25%, the percent of salt in the solids composition may be 80%, and the percentage of salt in the solution may be 20%. In such an example, the percent of carrier in the solids composition may be 20% and the percentage of carrier in the solution may be 5%.

In another illustrative example, the percent solids in the slurry may be 25%, the percent of salt in the solids composition may be 60%, and the percentage of salt in the solution may be 15%. In such an example, the percent of carrier in the solids composition may be 40% and the percentage of carrier in the solution may be 10%.

In another illustrative example, the percent solids in the slurry may be 25%, the percent of salt in the solids composition may be 48%, and the percentage of salt in the solution may be 12%. In such an example, the percent of carrier in the solids composition may be 52% and the percentage of carrier in the solution may be 13%.

In another illustrative example, the percent solids in the slurry may be 20%, the percent of salt in the solids composition may be 70%, and the percentage of salt in the solution may be 14%. In such an example, the percent of carrier in the solids composition may be 30% and the percentage of carrier in the solution may be 6%.

In another illustrative example, the percent solids in the slurry may be 20%, the percent of salt in the solids composition may be 60%, and the percentage of salt in the solution may be 12%. In such an example, the percent of carrier in the solids composition may be 40% and the percentage of carrier in the solution may be 8%.

In another illustrative example, the percent solids in the slurry may be 20%, the percent of salt in the solids composition may be 50%, and the percentage of salt in the solution may be 10%. In such an example, the percent of carrier in the solids composition may be 50% and the percentage of carrier in the solution may be 10%.

In another illustrative example, the percent solids in the slurry may be 15%, the percent of salt in the solids composition may be 70%, and the percentage of salt in the solution may be 10.5%. In such an example, the percent of carrier in the solids composition may be 30% and the percentage of carrier in the solution may be 4.5%.

In another illustrative example, the percent solids in the slurry may be 15%, the percent of salt in the solids composition may be 60%, and the percentage of salt in the solution may be 9%. In such an example, the percent of carrier in the solids composition may be 40% and the percentage of carrier in the solution may be 5%.

In another illustrative example, the percent solids in the slurry may be 15%, the percent of salt in the solids composition may be 50%, and the percentage of salt in the solution may be 7.5%. In such an example, the percent of carrier in the solids composition may be 50% and the percentage of carrier in the solution may be 7.5%.

In another illustrative example, the percent solids in the slurry may be 36%, the percent of salt in the solids composition may be 60%, and the percentage of salt in the solution may be 21.6%. In such an example, the percent of carrier in the solids composition may be 40% and the percentage of carrier in the solution may be 14.4%.

In some embodiments, the aqueous slurry may comprise the salt plus the carrier in an amount of about 10% to 36% by weight of the aqueous salt-carrier slurry and salt in an amount about 2.5% to less than 25% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%. For example, the percent solids in the slurry may be 36%, 25%, 20%, 15%. In an illustrative example, when the percent solids in the slurry is 15%, the percent of water content in the slurry is 85%.

At step 400, an aqueous salt-carrier slurry is fed into a nozzle of a drying chamber that has several orifices to spray out the slurry at different angles and drop sizes that can affect particle sizes into a drying chamber at step 500 with particle sizes inversely proportional to the angle aperture and directly proportional to the orifice aperture. The inlet temperature of the drying chamber is preferably 360° F.±25° F. Changing the amount of slurry that is pumped through the nozzle at step 400 can control the moisture content to 1.2% to 5%. Moisture content is the water content of the resulting product. The amount of slurry pumped through the nozzle into the drying chamber is controlled through the pump and compressor while slowed by the nozzle resistance (pressure drop).

The slurry should remain in the drying chamber until desired moisture content is reached and either precipitates to the collection hopper or is pulled by the cyclone as per regular Spray Drying practices, when they exit the outlet of the drying chamber at a temperature of 200° F.±25° F., followed by a cyclone at step 700 that collects the smaller particles that are too light to gravitate on the drying chambers hopper, a step particularly important as particle sizes of this process generates more smaller particles than typical spray drying processes. There is a suction blower/scrubber process at step 750 and a bagger process at step 800 that bags the resulting salt-carrier particles.

The salt-carrier mixture can then be subjected to a process to drive off (evaporate) water. In general, it can be advantageous to drive off water quickly, so as to reduce the growth time of salt nuclei that form on the surface of the carrier during the drying process. Exemplary processes for removing water from the carrier-slurry mixture include spray drying, spray cooking, freeze drying, and drum drying, among others.

In one approach, the average size of the salt particles can be controlled by adjusting parameters during the drying process, e.g., a spray-drying process, including one or more of (not by way of limitation): the ratio of salt-to-carrier in the slurry as described in the examples above, and spray drying parameters, including one or more of the inlet temperature, pump speed, air flow, and compressor pressure. It will be understood that various other means can be used to achieve similar results. Drying temperatures and times may vary particularly when methods other than spray drying are used in the drying process.

The process shown in FIG. 1 may produce salt particles of an average size of 100 nanometers to less than 50 microns adhered to or on the surface of the carrier, in combination, forming a plurality of salt-carrier particles. In some examples, the process may produce salt particles of an average size of less than 30 microns adhered to or on the surface of the carrier. The plurality of salt-carrier particles produced in accordance with the aforementioned process generally form a powder-like substance, namely, having the texture, flowability, look, feel and other characteristics of a powder.

In accordance with embodiments of the present invention, a low sodium salt powder composition may be formed by a process comprising: providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle. In accordance with some embodiments, the low sodium salt powder composition formed utilizing the foregoing process may be transformed using the roller compaction and/or milling method disclosed herein to form low sodium salt granules and/or crystals.

In accordance with embodiments of the present invention, a low sodium salt powder composition may be formed by a process comprising: providing an aqueous salt-carrier slurry comprising an aqueous solvent and a selected percent by weight of a solids mixture, wherein the solids mixture comprises a salt present in an amount between about 2.5% by weight and less than 14.9% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and exposing the aqueous salt-carrier slurry to a drying process to both: A) form a carrier particle comprised of the carrier medium; and B) form a plurality of salt particles of an average size of less than 100 nanometers on the surface of the carrier particle. In accordance with some embodiments, the low sodium salt powder composition formed utilizing the foregoing process may be transformed using the roller compaction and/or milling method disclosed herein to form low sodium salt granules and/or crystals.

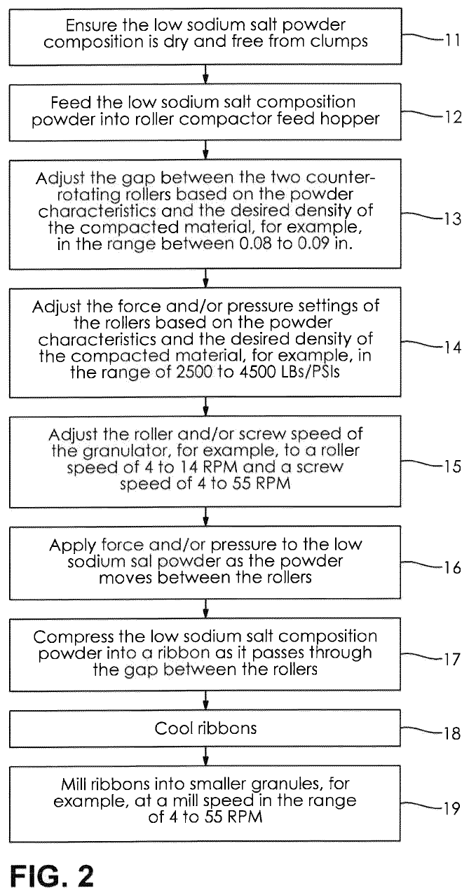

FIG. 2 is an exemplary flowchart demonstrating a process for forming low sodium salt granules including the following steps, which need not necessarily be performed in the order presented: (1) at step 11, ensure the low sodium salt composition powder is dry and free from clumps (e.g., mill or screen the powder to achieve the desired particle size and distribution); (2) at step 12, feed the low sodium salt composition powder into the roller compactor's feed hopper (e.g., using a screw feeder that controls the powder flow rate to ensure consistency); (3) at step 13, adjust the gap between the two-counter-rotating rollers based on the powder characteristics and the desired density (e.g., bulk density) of the compacted material; (4) at step 14, adjust the force and/or pressure settings between the two-counter-rotating rollers based on the powder characteristics and the desired density (e.g., bulk density) of the compacted material (5) at step 15, Adjust the roller speed of the granulator, for example, a roller compactor having a pair of rollers with a width of 1.22 inch (3.1 cm) and a roller diameter of 7.8 inches (200 mm) (each) to a roller speed of 4 to 14 RPM and a screw speed of 4 to 55 RPM (6) at step 16, apply force and/or pressure (e.g., high force and/or pressure) to the low sodium salt powder as the powder moves between the rollers so that the rollers compress the powder into thin sheets, ribbons, or briquettes (e.g., depending on the rollers used in the process); (7) at step 17, compress the low sodium salt powder into a ribbon or sheet as it passes through the gap between rollers, the gap and applied force/pressure determining the thickness and density of the ribbons or sheets; (8) optionally, at step 18, cool the ribbons or sheets after compression to make them easier to handle; (9) at step 19, pass the ribbons or sheets through a milling machine to break the ribbons or sheets into smaller particles (e.g., granules), depending on the desired particle size for the final product; (10) screen the granules to separate them into different size fractions to ensure uniformity and consistency in the final product; and (10) as an optional step, recycle oversized and fines of low sodium salt granules back through the compaction process to be reprocessed.

In accordance with embodiments of the present invention, the gap between the two-counter-rotating rollers for a compactor with a roller's width of 1.22 inch (3.1 cm) and a roller diameter of 7.8 inches (200 mm) may be anywhere between 0.08 to 0.09 inches (in). In a preferred embodiment, the gap between the two-counter-rotating rollers is 0.085 in.

In accordance with embodiments of the present invention, the average thickness and density (e.g., bulk density) of the low sodium salt ribbons can be controlled by adjusting the size of the gap between the counter-rotating rolls and/or the force/pressure applied to the composition.

In accordance with embodiments of the present invention, the roll force applied to the low sodium salt composition powder may be anywhere between 2500 to 6500 pounds-force (lbf) (approximately 11,120 to 28,913 Newtons), and more particularly, between 2500 to 4500 lbf (approximately 11,120 to 20,017 Newtons). In some scenarios, the roller pressure (which may be measured based on the roll force applied by the roller divided by the effective contact area between the rollers, for example, the roller pressure may be measured by dividing the force pound per the roller width size (e.g., the size or surface area that comes in contact with the material when the material travels through the roller compactor machine)) may be approximately 2000 to 5400 lbf/inch (approximately 3502 to 9456 N/cm), and more particularly, between 2000 to 3750 lbf/inch (approximately 3502 to 6567 N/cm. In some examples, the roll force may be anywhere between 3000 to 3500 lbf (approximately 13,345 to 15,569 Newtons) and the roll pressure may be anywhere between 2500 to 2916 lbf/in (approximately 4378 to 5106 N/cm). In a preferred embodiment, the roll force applied to the low sodium salt composition powder is 3000 lbf (approximately 13,345 Newtons) and the roller pressure is approximately 2500 lbf/in (approximately 4378 N/cm). In another preferred embodiment, the roll force applied to the low sodium salt composition powder is 3500 lbf (approximately 15,569 Newtons) and the roller pressure is approximately 2916 lbf/in (approximately 5106 N/cm). In some embodiments, the roller force may be in the range of 2000-3700 lbf (approximately 8,896 to 16,458 Newtons) and the roller pressure per inch of the roller width may be 2500-2900 lbf per inch or 4,378 to 5,106 Newtons per centimeter of the roller width. The foregoing force and pressure ranges may be applied when using a compactor with a width of 1.22 inch (3.1 cm) and a roller diameter of 7.8 inches (200 mm) and/or any other similarly suitable roller compactor, however, the force/pressure may need to be re-calculated based on the specifications of a particular machine, for example, based on the width and/or diameter of the rollers of a given roller compaction machine. Accordingly, it may be desirable to quantify the force/pressure applied by the roller compaction in a manner that may be applicable among a range of different roller compaction machines produced by different manufacturers. For example, for every inch that a roller width increases, the roller force applied by the machine should increase, for example, by 2000 to 3700 lbf. Moreover, the force applied to compact the fine powder can be exerted through various methods, each employing different techniques for transferring the force to the powder as it passes through the system, whether directly or indirectly. Different machines (e.g., different roller compaction machines) may utilize different equipment, for example, digital panels or electrical dials which may require different input parameters, however, the final force on the powder is what will generate the appropriate compaction in the granulation.

Regardless of the specific method used to control or express the force in different machines, the fundamental principle remains the same: all systems are ultimately designed to apply a precise amount of force to compress the powder. Whether through electronic controls, manual adjustments, or other mechanisms, each machine, in one way or another, must effectively know, apply and regulate the force applied to achieve the desired granulation outcome.

The roller diameter plays an important role in determining the rotational speed (RPM) necessary for achieving the desired dwell time during the compaction process. Dwell time, defined as the linear velocity at which the powder passes through the rollers, should be adjusted in proportion to the roller diameter to ensure consistent compaction. For the purposes of pressure calculations discussed herein, a roller diameter of 200 mm (20 cm) is used as a reference, recognizing that adjustments to RPM may be necessary when using rollers of different diameters to maintain equivalent dwell time and compaction performance.

In accordance with embodiments of the present invention, the need to produce more throughput of granules should be balanced with the functioning of the process (e.g., function of the roller compaction machine) since, at high roller force (e.g., 5000 to 6000 lbf or 22,241 to 26,389 Newtons), hard or brittle low sodium salt ropes/ribbons may be produced that may not mill properly or may cause mill jams. Advantageously, a roll force in the range of 3000 to 3500 lbf or 13,345 to 15,569 Newtons and/or roll pressure of between 2500 to 2916 lbf/inch (approximately 4303 to 5022 Newtons/inch), may produce a significant throughput or output of low sodium salt granules, without compromising the process (e.g., by producing brittle ribbons or jamming the mill) or the quality or characteristics (e.g., durability, flowability, or other qualities or characteristics) of the low sodium salt granules.

In any embodiment, the granulation parameters may need to be specified to a specific roller compactor (e.g., a roller compactor with rollers having a width of 1.22 inch (3.1 cm) and a roller diameter of 7.8 inches (200 mm)). One of ordinary skill in the art will recognize and would be able to make the appropriate adjustments to the process when a compactor and/or rollers of a different size are used.

In accordance with embodiments of the present invention, the roller speed applied to the low sodium salt composition powder may be anywhere between 4 to 14 revolutions per minute (RPM). In some examples, the roller speed may fall anywhere within the following ranges: 4 to 6 RPM, 6 to 12 RPM, and 12 to 14 RPM. In a preferred embodiment, the roller speed applied to the low sodium salt composition powder is 6 RPM. In another preferred embodiment, the roller speed applied to the low sodium salt composition powder is 12 RPM. In any embodiment, the roller speed may be any speed within the range provided, including, for example, 4 RPM, 6 RPM, 8 RPM, 10 RPM, 12 RPM, 14 RPM.

In accordance with embodiments of the present invention, the screw speed applied by the roller compaction machine may be anywhere between 4 to 55 RPM, for example 4 to 15 RPM, 6 to 22 RPM, 15 to 22 RPM, or 22 to 50 RPM. In a preferred embodiment, the screw speed applied by the roller compaction machine is 6 RPM. In another preferred embodiment, the screw speed applied by the roller compaction machine is 15 RPM. In any embodiment, the screw speed may be any speed within the range provided, including, for example, 5 RPM, 10 RPM, 15, RPM, 20 RPM, 25 RPM, 30 RPM, 35 RPM, and 40 RPM.

In accordance with embodiments of the present invention, an increased screw speed (e.g. from 6 RPM to 15 RPM), increased roll speed (e.g., from 6 RPM to 12 RPM), and slight increase of the roll force (e.g., from 3000 to 3500 lbf or 13,345 to 15,569 Newton) and/or a roll pressure (e.g., from 2500 to 2916 lbf/inch (approximately 4303 to 5022 Newtons/centimeter)) may significantly increase the throughput (e.g., production of the low sodium salt granules produced by the process disclosed herein), without any significant or other impact on the quality of the low sodium salt granules. In some examples, throughput may be increased from 15 kilograms per hour (kg/hr) to 36 kg/hr based on the increased screw speed, roll speed, and roll force/pressure described above.

In accordance with embodiments of the present invention, the mill speed applied by the milling machine may be anywhere 100 to 300 RPM. In a preferred embodiment, the mill speed applied by the milling machine is 150 RPM. In another preferred embodiment, the mill speed applied by the milling machine is 250 RPM. In any embodiment, the mill speed may be any speed within the range provided, including, for example, 100 RPM, 150 RPM, 200, RPM, 250 RPM, and 300 RPM.

In accordance with embodiments of the present invention, when the mill is integrated with the compaction system, (e.g., where the mill is directly fed by the compactor), the milling speed may be dictated by the compaction rate, for example, in order to keep up with the feed from the compactor.

In an embodiment where the mill is operated independently from the compactor (e.g., the mill is not integrated with the compactor system), the mill speed may be controlled, for example, to produce or manage a desired size distribution and/or minimize over heating of the product.

In accordance with embodiments of the present invention, one or more mill screens applied to the granules in the milling machine may be anywhere from 5 mesh to 40 mesh sieves (e.g., the number of openings in one linear inch of any mesh screen or sieve, for example, a 10 mesh sieve will have 10 openings and a 400 mesh sieve will have 400 openings in one linear inch). In a preferred embodiment, the mill screen applied to the granules in the milling machine is 10-35 mesh. In another preferred embodiment, the mill screen applied to the granules in the milling machine is 30 mesh. In some scenarios, the mill screens may be in the range of 400 to 4000 microns, for example, 500 microns or 2000 microns. In a preferred embodiment, the mill screen applied to the granules in the milling machine is produces granules of the size 500 to 1000 microns, however, granules of any size may be produced utilizing other screen sizes in order to produce granules of a desired size and having desired functional and/or aesthetic features.

In accordance with embodiments of the present invention, the granule throughput or output of the roller compaction and/or milling machines may be anywhere from 30 lbf/hour to 85 lbf/hour or 133 N/hr to 378 N/hr, however, this may vary depending on the size of the machine being utilized. The throughput may be less or greater, depending on the desired output of a given process or manufacturer. In accordance with embodiments of the present invention, the throughput of the low sodium salt composition granules may be increased utilizing the same or similar process parameters as disclosed herein, without significantly impacting (or otherwise effecting) the quality and other characteristics of the low sodium salt.

In accordance with embodiments of the present invention, the resultant low sodium salt granule or crystal composition may have a particle size between 100 μm-1000 μm (e.g., depending on the type of mesh screen used) and a bulk density of 0.60 grams per milliliter (g/ml) to 0.0.95 g/ml, including, for example, 0.60 g/ml to 0.66 g/ml, 0.66 g/ml to 0.75 g/ml, and/or 0.75 g/ml to 0.80 g/ml. In a preferred embodiment, the particle size of the final low sodium salt granule or crystal composition is between 150 μm-700 μm. In some embodiments, the low sodium salt granules may have a bulk density of 0.66 g/ml or 0.85 g/ml.

In accordance with exemplary process parameters of a first non-limiting exemplary process of the present invention, a roller compaction and/or milling process may be operated with one or more standard serrated or smooth surface rollers, a roll force of 3000 LBs (approximately 13,345 N), a roll pressure of 2500 lbf/in (approximately 4304 N/cm), a roll speed of 6 RPM, a screw speed of 22 RPM, a mill screen of 30 mesh, and a mill speed of 150 RPM.

In accordance with exemplary process parameters of a second non-limiting exemplary process of the present invention, a roller compaction and/or milling process may be operated with one or more standard serrated rollers, the roll force may be 3500 LB-fs (approximately 15,569 N), the roll pressure may be 2916 lbf/in (approximately 5106 N/cm), the roll speed may be 12 RPM, the screw speed may be 50 RPM, the mill screen may be 30 mesh, and the mill speed may be 250 RPM. In accordance with embodiments of the present invention, the second exemplary process may maximize production of throughput granules. For example, may produce the desired low sodium salt granules faster without impacting the granules' characteristics, including, durability (e.g., the ability to resist degradation) and flowability characteristics.

Advantageously, increasing the screw speed and roll speed and slightly increasing the roll force (e.g., from 3000 lbf to 3500 lbf or 13,345 to 15,569 Newtons) and/or roll pressure (e.g., from 2500 to 2916 lbf/in (approximately 4378 to 5106 N/cm), as demonstrated by the comparison of the first exemplary process and the second exemplary process, enables an increased (e.g., significant increase) of throughput of low sodium salt granules, without having an impact on the quality of the low sodium salt granules. Additionally, upon testing of such low sodium salt granules by subjecting the granules to a V-blending process (e.g., a five-minute blending process), the low sodium salt granules were found to be robust enough to handle blending (e.g., not degrade upon blending).

In accordance with embodiments of the present invention, the need to produce more throughput of granules needs to be balanced with the functioning of the process (e.g., function of the roller compaction machine) since, at high roller compaction roller force (e.g., 5000 to 6000 lbf or 22,241 to 26,389 N) and/or roller pressure (e.g., 4166 to 5000 lbf/in or 7295 to 8756 N/cm), hard or brittle low sodium salt ropes/ribbons may be produced that may not mill properly or may cause mill jams.

In accordance with embodiments of the present invention, granule or crystal samples may be tested for key parameters such as particle size distribution, flowability, and moisture content, for example, to assess whether the material meets the necessary or desired quality standards.

In accordance with embodiments of the present invention, the compaction process may include additional or further steps, for example, adjusting the temperature, humidity, and/or introducing one or more binding agents to facilitate crystal or granule formation. In some scenarios, one or more anti-caking agents may be introduced to the process to prevent unwanted clumping of the low sodium salt composition during the process (e.g., while in the queue to be processed).

In accordance with embodiments of the present invention, the size and bulk density of the low sodium salt granules or crystals may be controlled by adjusting parameters during the roller compaction and/or milling process, including one or more of (not by way of limitation): the roller or screw speed parameters, roller force or pressure, roller gap, mill screen mesh size, and/or mill speed. It will be understood that various other means can be used to achieve similar results. The roller compaction and/or milling process parameters may vary, including when a large amount of low sodium salt granule output is desired.

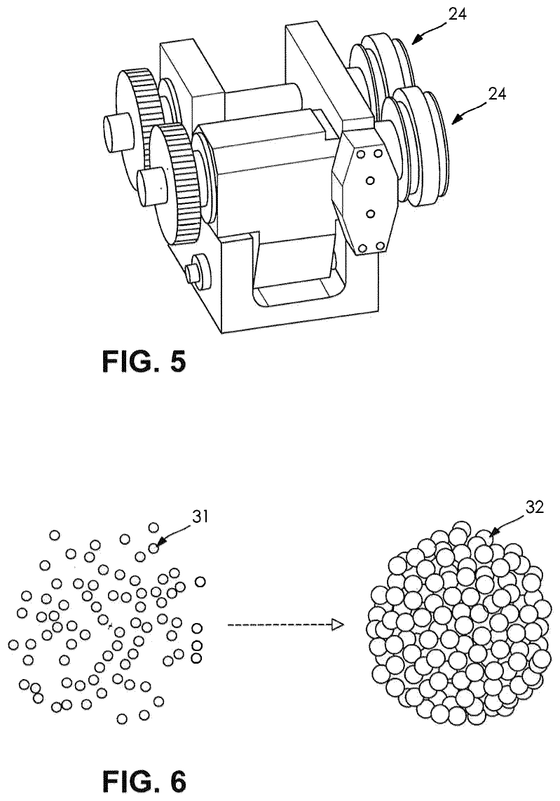

As shown in FIGS. 4-5, in accordance with embodiments of the present invention, a roller compaction system 20 may comprise a feed hopper 21, cantilevered roll design 22, one or more feed screws 23, for example, a vertical and/or horizontal feed screw which may or may not be tapered, a pivot point, and one or more serrated or smooth rollers 24 capable of exerting a roll force and/or hydraulic pressure. In some examples, the system 20 may comprise a milling mechanism 25 which may comprise one or more rotating milling components 26 and a sieve or screen 27.

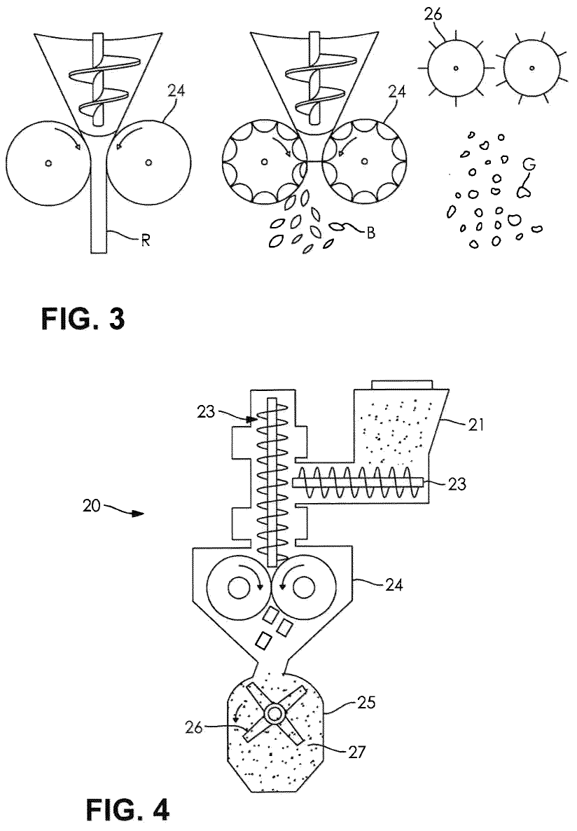

In accordance with embodiments of the present invention, the roller compaction system may feature a cantilevered roll design that supports the rolls at one end to provide stability and ease of maintenance. In some examples, the roller compaction system may feature rollers that move together (e.g., at the time time), one at a time, consecutively, and/or independently of one another (e.g., one fixed roll and one floating roll), depending on the intended output of the system. Such features may allow for precise control over the compaction process and may reduce mechanical complexity. In some examples, the system may include a vertical and/or horizontal tapered feed screw to facilitate the even distribution of powdered low sodium salt into the compaction area. The tapered design may help in achieving a consistent feed rate and uniform compaction. In some embodiments, one or more standard or custom designed serrated or smooth rolls may be employed in the system to compact the powdered low sodium salt into sheets, ribbons, and/or briquettes. The serrations may be configured to ensure that the material is uniformly compressed to enhance the granulation process. Optional rolls with different surface profiles (e.g., customized surface profiles) and/or different roll settings (e.g., speed, hydraulic pressure, and/or timing), may be used to achieve specific granulation characteristics. For example, as demonstrated in FIG. 3, a roller compaction system may be configured with smooth rollers to produce ribbons R, or with serrated rollers to produce briquettes B. The ribbons T and/or the briquettes B, may subsequently be milled into granules G.

In accordance with embodiments of the present invention, powdered low sodium salt may be introduced into the roller compaction system via a vertical and/or horizontal feed screw. The feed screw may direct the powdered low sodium salt into a gap between the two rolls. In some embodiments, the rolls, rotating in opposite directions (or having one roll in a fixed position and one in a floating position), may exert pressure on the powdered low sodium salt, compacting it into uniform sheets. The cantilevered roll design may allow for precise adjustment of the roll gap to control the density and hardness of the compacted sheets. The compacted sheets may then be passed through a granulator or suitable breaking down mechanism and/or one or more milling machines to produce low sodium salt crystals of desired size. For example, a sifting machine (e.g., a Sweco vibratory sifting) may be utilized to screen out overs (particles larger than the desired output) from a given batch, and a second sifting or screening machine (e.g., a Turbo Mill®) to screen out fines (e.g., particles smaller than the desired output) from a given batch. Other available sifting (screening) machines may similarly be used, for example, StarMill®, Gyra-Vib®, or any other similarly suitable screener. Accordingly, the one or more milling machines may break down and mill the sheets into granules suitable for various applications.

In accordance with embodiments of the present invention, utilizing a roller compaction system to granulate powdered low sodium salt may have several advantages including granule uniformity and ease of use. In some examples, utilizing a roller compaction system to granulate powdered low sodium salt produces semi-spherical granulated low sodium salt. FIG. 6 is an illustrative example demonstrating exemplary low sodium salt compositions before and after undergoing the roller compaction process described herein. As shown in FIG. 6, low sodium salt powder 31 may be roller compacted to form spherical granulated low sodium salt 32. In some examples, the roller compaction system may support consistent sheet formation, resulting in uniform granules, for example, with controlled hardness and density (e.g., bulk density). In some embodiments, the system may be configured for simplicity in operation, making it easy to convert low sodium salt powder to easy to use and handle salt crystals.

Persons of ordinary skill in the art would appreciate that, typically (e.g., prior to the development of the presently disclosed methods), roller compaction would not be considered or used to transform low sodium salt powders to low sodium salt crystals or granules based on at least one or more of the following actual or perceived obstacles: (1) roller compaction may not be ideal for powders, such as low sodium salt powders, with high moisture content because high moisture can lead to issues such as clumping, reduced effectiveness of compaction, and potential damage to equipment; (2) powders, such as low sodium salt powders, may have poor flowability characteristics or may be too cohesive or may not compact well between the roller compactor rollers; (3) powders, such as low sodium salt powders, with low bulk density, may not compact effectively; (4) the hardness of the granules, such as low sodium salt granules, produced by roller compaction may be too high or too low, (5) at high roller compaction roller force (e.g., 5000 to 6000 LB-fs or 22,241 to 26,389 Newton), hard or brittle low sodium salt ropes/ribbons may be produced that may not mill properly or may cause mill jams.

The present disclosure addresses the foregoing issues by utilizing the parameters specified herein to form the low sodium salt granules and/or crystals, e.g., using standard serrated or smooth rollers, a roll force of 3000 to 3500 lbf (approximately 13,345 to 15,569 Newtons), a roll pressure of 2500 to 2916 lbf/in (approximately 4378 to 5106 N/cm), a roll speed of 6 RPM or 12 RPM, a screw speed of 22 RPM to 50 RPM, a mill screen of 30 mesh, and a mill speed of 150 or 250 RPM.

In accordance with embodiments of the present invention, the salt granules and/or crystals produced by the process described herein may be configured to be dispensed by traditional salt dispensers for ease of handling and user convenience. For example, the salt crystals formed by the process described herein may be handled and dispensed by saltshakers, such as the Sonoco Plastics® Accusalt® Ww saltshaker, with small, cylindrical or square containers with holes in the lid, wherein salt may be dispensed by shaking the container, which allows salt to come out through the holes. Moreover, the salt crystals formed by the process described herein may be handled and dispensed by pour spout dispensers, which feature a spout or nozzle for controlled pouring of salt, and may be utilized to add a precise amount of salt to dishes or recipes. In accordance with embodiments of the present invention, the salt granules and/or crystals produced by the process described herein may be configured to be dispensed in a nature and manner similar or identical to the nature and manner that traditional table salt crystals are dispensed and distributed. The present disclosure contemplates use of any salt dispenser available in the art for dispensing traditional table salt (e.g., table salt crystals) for dispensing the salt crystals produced by the process described herein.

In accordance with embodiments of the present invention, the roller compacting process disclosed herein may produce durable (e.g., substantially non-degradable upon blending) granulated salt with improved flowability. To demonstrate this, Applicants conducted friability testing to evaluate granule durability. During a generic-type friability test, the amount of fines from a 200 g sample of the granules produced in accordance with the roller compaction methods disclosed herein (e.g., Example A and Example B Granules described below) were compared to the amount of fines that were present in a separate 200 g sample that had undergone a particular tumbling process (described in more detail below), and it was found that before the tumbling process, 2.7 g of fines where present after screening with a 100 mesh screen, and after the tumbling process, 3.8 g of fines where present after screening the sample with a 100 mesh screen. This demonstrates that after the tumbling process, there was only a 0.55% increase in the amount of fines present after sifting the 200 g sample, meaning that the sample was able to substantially withstand the tumbling process and is demonstrably durable.

The tumbling process described above included using a V-blender to blend 3 kg of granule samples and tumble mixing the samples for five minutes.

In another test to demonstrate the durability of the granule samples, a second generic friability test of attrition was conducted. In such a test, a 100 g sample of Example B Granules and five 3/2 in. nuts were loaded on a 100 mesh screen. The screen was loaded onto a sieve shaker (Ro-Tap®) with a pan at the bottom for collecting fines. The sieve shaker ran for five minutes. At the end of the five minutes, the fines were weighed out and quantified. The testing process was repeated multiple times and showed that there were approximately 1.5-2.2% of fines that passed the 100 mesh screen.

In accordance with embodiments of the present invention, the roller compacting process disclosed herein may produce semi spherical to irregular shaped granulated salt.

In accordance with embodiments of the present invention, the roller compacting process disclosed herein may utilize relatively low roller force (e.g., 3000 to 4000 lbf (approximately 13,344 to 17,792 Newton) of force) and/or roller pressure (e.g., 2500 to 3333 lbf/in (approximately 4378 to 5836 N/cm) to produce a better processable compaction, with less brittle low sodium salt ribbons or sheets, which can be milled with ease (e.g., when compared to processes utilizing higher roller force or pressure to produce low sodium salt sheets or ribbons for eventual milling).

In accordance with embodiments of the present invention, utilizing a higher roller force and/or pressure may produce granules with increased hardness. Below is a table demonstrating the hardness in grams for granules produced with all the same processing parameters and a variable roller pressure:

| Sample | Roller Force | Hardness |
|---|---|---|
| 1 | 2500 lbf (11,120 Newton) | 12402 g |
| | | (standard deviation value = 406) |
| 2 | 3500 lbf (15,569 Newton) | 12498 g |
| | | (standard deviation value = 542) |
| 3 | 4500 lbf (20,017 Newton) | 12834 g |
| | | (standard deviation value = 364) |
| 4 | 5500 lbf (24,465 Newton) | 14737 g |
| | | (standard deviation value = 607) |
| 5 | 6500 lbf (28,913 Newton) | 15687 g |
| | | (standard deviation value = 710) |

As demonstrated by the above test-results, the required force to completely pulverize the granules increase the processing force and hardness of the granules, but also increases the standard deviation. The differential force required to pulverize the granules is about 23%, meaning that using 6500 lbf (approximately 28,913 Newtons) of roller force and/or 5416 lbf/in (approximately 9484 N/cm) of roller pressure during the granule formulation process created an approximate 23% stronger granule on average.

In accordance with embodiments of the present invention, the percentage of salt to carrier in the preparation of the salt-carrier slurry used to produce the low sodium salt powder composition, and different combinations of the other process parameter described herein, may dictate the final properties of the powder and/or the roller compacted low sodium salt granules produced using such powders. For example, the difference in ratio of salt to carrier used in the low sodium salt production process may dictate whether the resultant low sodium salt powder composition may adhere better to foods, flow better out of dispensers, have a stronger or more intense salty taste or profile, or dissolve better (e.g., at a better dissolution rate or percentage) when eaten.

To further illustrate the above concept, two non-limiting examples will be described below. These examples represent specific cases within a broader spectrum of possible formulations and are non-limiting in the sense that the process of the low sodium salt powder production through varying salt or carrier content can be adapted to a wide range of other formulations with different percentages of salt or carrier content or other parameters used to form the salt-carrier slurry, or any other processing conditions within those described herein.

Example A Powder: about 60% salt (e.g., sodium chloride) and about 40% carrier (e.g., maltodextrin) is used to produce a salt-carrier slurry, which undergoes a drying process to become a low sodium salt powder composition.

Example A Granules: The low sodium salt powder composition undergoes a dry granulation process using a roller compaction process (e.g., using a Freund® TFC 220 roller compactor). The low sodium salt powder composition described as Example A Powder above is screw fed between two rotating corrugated rollers (standard serrated rollers) at a screw speed of 50 RPM, and pressed into a ribbon-like low sodium salt product, where the roll force of the rollers is 3,500 lbf (approximately 15,569 Newtons), the roll pressure is 2916 lbf/in (approximately 5106 N/cm) and the roll speed of the rollers is 12 RPM. The compacted material is gravity fed into a built in hammer mill with a bottom 30 sieve screen running at a mill speed of 250 RPM. The resultant milled low sodium salt product is collected and then sifted to a desired particle size distribution.

Example B Powder: about 75% salt (e.g., sodium chloride) and about 25% carrier (e.g., maltodextrin) is used to produce a salt-carrier slurry, which undergoes a drying process to become a low sodium salt powder composition.

Example B Granules: The low sodium salt powder composition undergoes a dry granulation process using a roller compaction process (e.g., using a Freund® TFC 220 roller compactor). The low sodium salt powder composition described as Example B Powder above is screw fed between two rotating corrugated rollers (standard serrated rollers) at a screw speed of 50 RPM, and pressed into a ribbon-like low sodium salt product, where the roll force of the rollers is 3,500 lbf (approximately 15,569 Newtons), the roll pressure is 2916 lbf/in (approximately 5106 N/cm), and the roll speed of the rollers is 12 RPM. The compacted material is gravity fed into a built in hammer mill with a bottom 30 sieve screen running at a mill speed of 250 RPM. The resultant milled low sodium salt product is collected and then sifted to a desired particle size distribution.

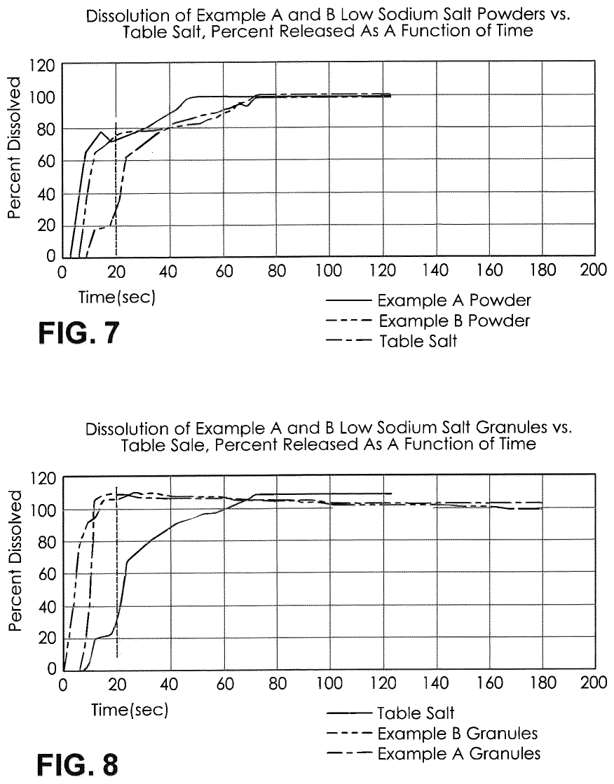

FIGS. 7-9 demonstrate test results based on dissolution test conducted to evaluate the dissolution rate of table salts and various low sodium salts of the present disclosure in water. The protocol of the tests included adding the table salts and low sodium salts into mixing DI water (e.g., agitated water) and monitoring sodium ions released as a function of time. Data was collected every three seconds using a selective sodium ion probe.

In accordance with embodiments of the present invention, low sodium salt powders, such as those produced in accordance with the processes described in Example A and Example B above, have a higher dissolution rate/percentage in less time. FIG. 7 is a graph based on a dissolution test conducted to evaluate the dissolution rate of table salt and the low sodium salt powders of Example A and Example B in water. As demonstrated by the graph, about 70% of the Example A and B powders dissolved into water within less than twenty seconds, whereas only about 30% of the tested table salt dissolved into the water within that same period of time.

In accordance with embodiments of the present invention, low sodium salt granules, such as those produced in accordance with the processes described in Example A and Example B above, have a higher dissolution rate/percentage in less time. FIG. 8 is a graph based on a dissolution test conducted to evaluate the dissolution rate of table salt and low sodium salt granules of Example A and B in water. The graph in FIG. 8 demonstrates the dissolution percentage over time of Example A and Example B granules as compared to standard/traditional table salt. As demonstrated by the graph, the Example A and B granules completely dissolved within less than twenty seconds, whereas only about 30% of the tested table salt dissolved into the water. Importantly, twenty seconds is a significant marker of time in the context of the dissolution of food additives, given that consumers tend to chew on foods (and expose taste buds on their tongue and mouth to the dissolving salts in those foods providing their salty flavor profile) for about twenty seconds on average, before swallowing those foods. Any salts not dissolved within the anatomy of the mouth (and thereby not tasted by the appropriate taste buds within the mouth) is left to dissolve in the rest of the gastrointestinal (GI) tract, without the benefit of providing a salty taste during that dissolution. Advantageously, the low sodium salt granules produced in accordance with embodiments of the invention, and in particular, Example A Granules and Example B Granules discussed above, have a dissolution percentage of over 90% by the twenty second mark, whereas traditional salts only have a dissolution percentage of about 20-30% at that same twenty second mark. Accordingly, such low sodium salt granules provide a significant increase to dissolution and salty taste when compared to traditional table salts.

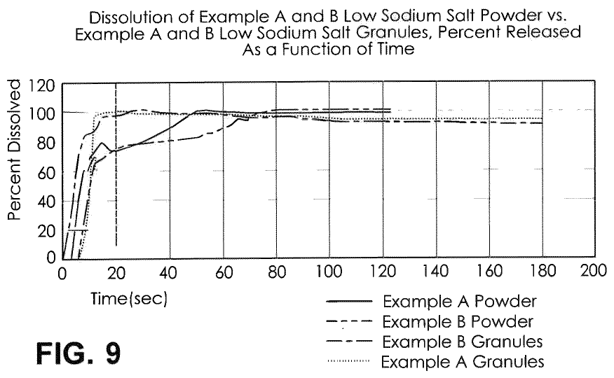

FIG. 9 is a graph based on a dissolution test conducted to evaluate the dissolution rate of low sodium salt powders of Example A and B (Example A and B powders) and low sodium salt granules of Example A and B (Example A and B Granules) in water. The graph in FIG. 9 demonstrates the dissolution percentage over time of Example A and Example B granules as compared to Example A and Example B powders. As demonstrated by this graph, the dissolution rate of the low sodium salt granules is around over 90% on average, which is at least 20% higher at the twenty second mark than the dissolution rate of the low sodium salt powders which is about 70% on average. Without wishing to be bound by theory, Applicants believe that the low sodium salt powders (e.g., Example A Powder and Example B Powder) are so fine that there is a high surface tension between the powders and the water when the two are introduced which makes it difficult (e.g., takes more time) for the powders to dissolve into the water.

Advantageously, the roller compaction and/or milling process of the present invention may be utilized to produce salt granules from any base salt, including any powder, crystal, flaky, and/or any other amorphous or milled salts, including low sodium powder, crystal, or flaky salts (e.g., Cargill® Alberger® Flake Salts and Morton® Extra Fine salts). In accordance with embodiments of the present invention, a base low sodium salt or salt-carrier product may include any low sodium salt powders, and not necessarily the low sodium salt produced in accordance with the process described above, including, for example, the low sodium salt products described in U.S. Pat. Nos. 8,900,650, 11,992,034, and 9,491,961 and any of the foregoing low sodium salt powders may be processed according to the roller compaction process parameters discussed herein. Furthermore, in certain scenarios, depending on the desired outcome, the base low sodium salt may or may not include a carrier particle.

In general, the methods provided herein can extend to other powdered crystals, including other foods and food additives as well. For example, using similar processes as those described above, sugar crystals or sugar-substitute crystals can be compacted utilizing a similar compaction process to provide an analogous granulized sugar compositions with desirable durability, flowability and/or other desirable particle characteristics described herein. Those with certain adverse health conditions, such as diabetes or obesity may find such granulized sugar compositions beneficial to their health. In accordance with embodiments of the present invention, roller compaction processes may be similar to the roller compaction processes utilized in pharmaceutical applications, for example, to densify and improve flowability of protein powders and flavors.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

A number of illustrative embodiments have been described. Nevertheless, it will be understood that various modifications may be made without departing from the spirit and scope of the inventive concepts presented herein.

As used herein, the phrases “nanometer- to micron-sized” or “nanometer- to micron-scale” and similar phrases carry their ordinary meaning, that is, they refer to objects having at least one dimension of nanometer or micron scale.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

While various embodiments of the present invention have been disclosed and described in detail herein, it will be apparent to those skilled in the art that various changes may be made to the configuration, operation and form of the invention without departing from the spirit and scope thereof. In particular, it is noted that the respective features of embodiments of the invention, even those disclosed solely in combination with other features of embodiments of the invention, may be combined in any configuration excepting those readily apparent to the person skilled in the art as nonsensical. Likewise, use of the singular and plural is solely for the sake of illustration and is not to be interpreted as limiting.

In the present disclosure, all embodiments where “comprising” is used may have as alternatives “consisting essentially of,” or “consisting of” In the present disclosure, any method or apparatus embodiment may be devoid of one or more process steps or components. In the present disclosure, embodiments employing negative limitations are expressly disclosed and considered a part of this disclosure.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f).

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A method for producing a granular low sodium salt composition comprising:
providing a low sodium salt powder composition comprising one or more salt particles adhered to a bulk carrier;
feeding the low sodium salt powder composition into a roller compaction machine;
compacting the low sodium salt powder composition using the roller compaction machine to form a low sodium salt compacted sheet; and
reducing the low sodium salt compacted sheet into low sodium salt granules, sifting the low sodium salt granules to a predetermined particle size and removing any uncompacted powder fines to obtain a granular low sodium salt composition.

2. The method of claim 1, wherein the wherein the low sodium salt powder composition is formed by a process comprising:
providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and
exposing the aqueous salt-carrier slurry to a drying process to both: A) form a carrier particle comprised of the carrier medium; and B) form a plurality of salt particles of an average size of less than 100 nanometers on the surface of the carrier particle.

3. The method of claim 1, wherein the roller compaction machine operates at a roller force in the range of 2500 to 4500 pounds-force or 11,120 to 20,017 Newtons.

4. The method of claim 1, wherein the roller compaction machine operates at a roller force in the range of 3000 to 3500 pounds-force or 13,345 to 15,569 Newtons.

5. The method of claim 1, wherein the roller compaction machine comprises a pair of rollers, each having a roller width, and the roller compaction machine operates at a roller pressure in the range of 2000 to 3700 pounds-force per inch of each roller width or 3,502 to 6,479 Newtons per centimeter of each roller width.

6. The method of claim 1, wherein the roller compaction machine comprises a pair of rollers, each having a roller width, and the roller compaction machine operates at a roller pressure in the range of 2500 to 2900 pounds-force per inch of each roller width or 4,378 to 5,078 Newtons per centimeter of each roller width.

7. The method of claim 1, wherein the roller compaction machine operates at a screw speed in the range of 6 to 22 RPM.

8. The method of claim 1, wherein a gap formed between two counter-rotating rollers of the roller compaction machine is 0.08 to 0.09 inches.

9. The method of claim 1, wherein the roller compaction machine operates at a roller speed in the range of 6 to 12 RPM.

10. The method of claim 1, wherein the low sodium compacted sheet is reduced to granules using a milling or crushing process with a mill speed of 100 to 300 RPM.

11. The method of claim 1, wherein the roller compaction machine operates at a screw speed in the range of 6 to 15 RPM, a roll speed in the range of 6 RPM to 12 RPM, a roll force in the range of 3000 to 3500 pounds-force, and a mill speed in the range of 150 RPM to 250 RPM.

12. The method of claim 11, wherein the granular low sodium salt composition produced by the claimed process is durable and substantially non-degradable, and has a dissolution rate of over 90% in less than 20 seconds.

13. The method of claim 11, wherein the granular low sodium salt composition produced by the claimed process possesses improved handling, dispensing, and flowability when compared to powdered low sodium salt compositions, and has a taste substantially similar to or better than table salt, with a significantly faster dissolution rate when compared to table salt.

14. The method of claim 1, wherein the low sodium salt granules have a particle size between 100-1000 μm and a bulk density in a range of 0.60 grams per milliliter (g/ml) to 0.95 g/ml.

15. The method of claim 1, wherein the granular low sodium salt composition produced by the claimed process possesses a carrier content in the range of 0-70% and the salts adhered to the bulk carrier have a salt crystal of size less than 20 μm.

16. A low sodium salt granule product produced by the following process:
providing a low sodium salt powder composition comprising one or more salt particles adhered to a bulk carrier;
feeding the low sodium salt powder composition into a roller compaction machine;
compacting the low sodium salt powder composition using the roller compaction machine to form a low sodium salt compacted sheet; and
reducing the low sodium salt compacted sheet into low sodium salt granules to obtain granular low sodium salt composition.

17. The low sodium salt granule product of claim 16, wherein the low sodium salt powder composition is formed by a process comprising:
providing an aqueous salt-carrier slurry comprising an aqueous solvent and a selected percent by weight of a solids mixture, wherein the solids mixture comprises a salt present in an amount between about 3.9% by weight and less than 25% by weight of the aqueous solvent, and a carrier medium present in an amount between about 2.77% by weight and less than 25% by weight of the aqueous solvent, wherein the aqueous salt-carrier slurry comprises the salt plus the carrier in an amount of about 10% to 36% by weight of the aqueous salt-carrier slurry, wherein the aqueous salt-carrier slurry is prepared by heating the salt, the carrier, and water to a temperature of about 176° F.±10° F. until the water, salt, and carrier are substantially dissolved to a moisture content of about 1.2% to 5%; and
exposing the aqueous salt-carrier slurry to a drying process to both: A) form a carrier particle comprised of the carrier medium; and B) form a plurality of salt particles of an average size of less than 100 nanometers on the surface of the carrier particle.

18. The low sodium salt granule product of claim 16, wherein the roller compaction machine operates at a roller force in the range of 2500 to 4500 pounds-force or 11,120 to 20,017 Newton.

19. The low sodium salt granule product of claim 16, wherein the roller compaction machine operates at a screw speed in the range of 4 to 55 RPM.

20. The low sodium salt granule product of claim 16, wherein a gap formed between two counter-rotating rollers of the roller compaction machine is 0.08 to 0.09 inches.

21. The low sodium salt granule product of claim 16, wherein the roller compaction machine operates at a roller speed in the range of 4 to 14 RPM.

22. The low sodium salt granule product of claim 16, wherein the low sodium compacted sheet is reduced to granules using a milling or crushing process with a mill speed of 100 to 300 RPM.

23. The low sodium salt granule product of claim 16, wherein the roller compaction machine operates at a screw speed in the range of 6 to 15 RPM, a roll speed in the range of 6 RPM to 12 RPM, a roll force in the range of 3000 to 3500 pounds-force or 13,345 to 15,569 Newton, and a mill speed in the range of 150 RPM to 250 RPM.

24. The low sodium salt granule product of claim 23, wherein the roller compaction machine operates without jamming the mill or producing brittle low sodium salt sheets.

25. The low sodium salt granule product of claim 23, wherein the low sodium salt granule product comprises low sodium salt granules that are durable and substantially non-degradable, and possesses a sodium chloride content between 10-100%.

26. The low sodium salt granule product of claim 23, wherein the low sodium salt granule product possesses improved handling, dispensing, and flowability when compared to powdered low sodium salt compositions.

27. The low sodium salt granule product of claim 16, wherein the low sodium compacted sheet is reduced to granules using a milling or crushing process with a mill speed of 100 to 300 RPM.

28. The low sodium salt granule product of claim 16, wherein the low sodium salt granule product possesses an appearance, flowability and taste that is similar to or better than table salt, with a significantly faster dissolution rate than table salt.

29. The low sodium salt granule product of claim 16, wherein the low sodium salt granules have a particle size between 100-1000 μm and a size distribution with a bulk density in a range of 0.60 grams per milliliter (g/ml) to 0.80 g/ml.

30. The low sodium salt granule product of claim 16, wherein each granule of the low sodium salt granule product possesses a bulk carrier content in the range of 0-70% and the salts adhered to the bulk carrier have a salt crystal of size less than 20 μm.

31. The low sodium salt granule product of claim 16, wherein the roller compaction machine comprises a pair of rollers, each having a roller width, and the roller compaction machine operates at a roller pressure in the range of 2000 to 3700 pounds-force per inch of each roller width or 3,502 to 6,479 Newtons per centimeter of each roller width.

32. The low sodium salt granule product of claim 16, wherein the roller compaction machine comprises a pair of rollers, each having a roller width, and the roller compaction machine operates at a roller pressure in the range of 2500 to 2900 pounds-force per inch of each roller width or 4,378 to 5,078 Newtons per centimeter of each roller width.
